(19) United States
(12) Patent Application Publication
(10) Pub. No.: US 2026/0079415 A1
(43) Pub. Date: Mar. 19, 2026

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Tsutomu FURUTA, Kanagawa (JP); Daisuke ISHIZUKA, Kanagawa (JP)

(73) Assignee: FUJIFILM Business Innovation Corp., Tokyo (JP)

(21) Appl. No.: 19/068,018

(22) Filed: Mar. 3, 2025

(30) Foreign Application Priority Data
Sep. 19, 2024 (JP) 2024-162552

(51) Int. Cl. G03G 9/08; G03G 9/087; G03G 15/08

(52) U.S. Cl. CPC G03G 9/0819; G03G 9/0817; G03G 9/0821; G03G 9/08742; G03G 9/08755; G03G 15/0865

(57) ABSTRACT

An electrostatic charge image developing toner contains toner particles that contain an amorphous polyester resin and a styrene-(meth)acrylic resin, in which the toner particles have a spherical domain A of the styrene-(meth)acrylic resin, that is insoluble in tetrahydrofuran, and a spherical domain B of the styrene-(meth)acrylic resin, that is soluble in tetrahydrofuran, a glass transition temperature Tg1 of the spherical domain A of the styrene-(meth)acrylic resin is 0° C. or higher and 35° C. or lower, and in a case where a glass transition temperature of the spherical domain B of the styrene-(meth)acrylic resin is denoted by Tg2, a value of Tg2−Tg1 is 20° C. or higher and 55° C. or lower.

### CROSS-REFERENCE TO RELATED APPLICATIONS

This application is based on and claims priority under 35 USC 119 from Japanese Patent Application No. 2024-162552 filed Sep. 19, 2024.

### BACKGROUND

### (i) Technical Field

The present invention relates to an electrostatic charge image developing toner, an electrostatic charge image developer, a toner cartridge, a process cartridge, an image forming apparatus, and an image forming method.

### (ii) Related Art

JP2016-62040A discloses an electrostatic charge image developing toner containing toner particles that contains a binder resin including a polyester resin, a release agent that includes a hydrocarbon-based wax, and a styrene-(meth)acrylic resin, in which 70% or more of the release agent is present within 800 nm from a surface of the toner particles, the styrene-(meth)acrylic resin in the toner particles forms a domain having an average size of 0.3 μm or more and 0.8 μm or less, and a proportion of the number of the domains included in a range of the average size ±0.1 μm is 65% or more.

JP2021-189408A discloses an electrostatic charge image developing toner containing toner base particles that contain at least a binder resin, in which the toner base particles are toner base particles formed by aggregation and fusion of fine particles of the binder resin and seed polymer fine particles, the seed polymer fine particles have an outer shell and a seed portion, a difference (Tg2−Tg1) between a glass transition temperature Tg1 of the seed portion and a glass transition temperature Tg2 of the outer shell is 50° C. or higher, the binder resin includes an amorphous resin having a glass transition temperature Tgm as a principle component, and the Tgm is higher than the Tg1.

### SUMMARY

Aspects of non-limiting embodiments of the present disclosure relate to an electrostatic charge image developing toner containing toner particles that have a spherical domain A of a styrene-(meth)acrylic resin, that is insoluble in tetrahydrofuran, and a spherical domain B of a styrene-(meth)acrylic resin, that is soluble in tetrahydrofuran, in which fogging suppression property and low-temperature fixability are excellent as compared with a case in which a glass transition temperature Tg1 of the spherical domain A of the styrene-(meth)acrylic resin is lower than 0° C. or higher than 35° C. or lower, or a case in which, in a case where a glass transition temperature of the spherical domain B of the styrene-(meth)acrylic resin is denoted by Tg2, a value of Tg2−Tg1 is lower than 20° C. or higher than 55° C.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following.

According to an aspect of the present disclosure, there is provided an electrostatic charge image developing toner containing toner particles that contain an amorphous polyester resin and a styrene-(meth)acrylic resin, in which the toner particles have a spherical domain A of the styrene-(meth)acrylic resin, that is insoluble in tetrahydrofuran, and a spherical domain B of the styrene-(meth)acrylic resin, that is soluble in tetrahydrofuran, a glass transition temperature Tg1 of the spherical domain A of the styrene-(meth)acrylic resin is 0° C. or higher and 35° C. or lower, and in a case where a glass transition temperature of the spherical domain B of the styrene-(meth)acrylic resin is denoted by Tg2, a value of Tg2−Tg1 is 20° C. or higher and 55° C. or lower.

### BRIEF DESCRIPTION OF THE DRAWINGS

Exemplary embodiment(s) of the present invention will be described in detail based on the following figures, wherein:

FIG. 1 is a view schematically showing the configuration of the image forming apparatus according to the present exemplary embodiment; and

FIG. 2 is a view schematically showing the configuration of the process cartridge according to the present exemplary embodiment.

### DETAILED DESCRIPTION

Exemplary embodiments of the present invention will be described below. The following descriptions and examples merely illustrate the exemplary embodiments, and do not limit the scope of the exemplary embodiments.

In the present exemplary embodiments, a numerical range described using “to” represents a range including numerical values listed before and after “to” as the minimum value and the maximum value respectively.

Regarding the numerical ranges described in stages in the present exemplary embodiment, the upper limit value or lower limit value of a numerical range may be replaced with the upper limit value or lower limit value of another numerical range described in stages. In addition, in the present exemplary embodiment, the upper limit value or lower limit value of a numerical range may be replaced with values described in examples.

In the present exemplary embodiment, the term “step” includes not only an independent step but a step that is not clearly distinguished from other steps as long as the intended purpose of the step is achieved.

In the present exemplary embodiments, each component may include a plurality of corresponding substances. In the present exemplary embodiment, in a case where the amount of each component in a composition is mentioned, and there are two or more kinds of substances corresponding to each component in the composition, unless otherwise specified, the amount of each component means the total amount of two or more kinds of the substances present in the composition.

In the present exemplary embodiments, each component may include a plurality of corresponding particles. In a case where there are two or more kinds of particles corresponding to each component in a composition, unless otherwise specified, the particle size of each component means a value for a mixture of two or more kinds of the particles present in the composition.

In the present exemplary embodiment, “(meth)acrylic” is an expression including both acrylic and methacrylic, and “(meth)acrylate” is an expression including both acrylate and methacrylate.

In the present exemplary embodiment, “electrostatic charge image developing toner” is also referred to as “toner”.

### Electrostatic Charge Image Developing Toner

The electrostatic charge image developing toner according to the present exemplary embodiment contains toner particles that contain an amorphous polyester resin and a styrene-(meth)acrylic resin, in which the toner particles have a spherical domain A of the styrene-(meth)acrylic resin, that is insoluble in tetrahydrofuran, and a spherical domain B of the styrene-(meth)acrylic resin, that is soluble in tetrahydrofuran, a glass transition temperature Tg1 of the spherical domain A of the styrene-(meth)acrylic resin is 0° C. or higher and 35° C. or lower, and in a case where a glass transition temperature of the spherical domain B of the styrene-(meth)acrylic resin is denoted by Tg2, a value of Tg2−Tg1 is 20° C. or higher and 55° C. or lower.

In the toner of the related art, a polyester resin has been employed as a binder resin in order to ensure low-temperature fixability, but the polyester resin is easily water-absorbing, and thus fogging occurs in a case of printing after being left in a high humidity environment for a long period of time. The “fogging” is a phenomenon in which an unintended dot-like image appears on the image forming surface of the recording medium.

The occurrence of fogging can be suppressed by containing styrene-(meth)acrylic resin particles in the polyester resin toner, but since affinity between the polyester resin and the styrene-(meth)acrylic resin is low, a domain of the styrene-(meth)acrylic resin is formed in the toner. The domains of the styrene-(meth)acrylic resin are also present in the image during fixing, and in a case where the fixed image is folded, breakage is likely to occur at an interface between the domain of the styrene-(meth)acrylic resin and the polyester resin, and thus it is difficult to achieve both suppression of occurrence of fogging and low-temperature fixability.

In the electrostatic charge image developing toner according to the present exemplary embodiment, the toner particles have a spherical domain A of the styrene-(meth)acrylic resin, that is insoluble in tetrahydrofuran, and a spherical domain B of the styrene-(meth)acrylic resin, that is soluble in tetrahydrofuran, where Tg1 of the spherical domain A of the styrene-(meth)acrylic resin is 0° C. or higher and 35° C. or lower, and in a case where a glass transition temperature of the spherical domain B of the styrene-(meth)acrylic resin is denoted by Tg2, the value of Tg2−Tg1 is 20° C. or higher and 55° C. or lower. Therefore, a part of the spherical domain B of the styrene-(meth)acrylic resin is exposed on a surface of the toner particles, it is difficult to reduce charging of the toner, the occurrence of fogging can be suppressed, in a case of fixing, the molten spherical domain B of the styrene-(meth)acrylic resin is incorporated into a network structure portion of the spherical domain A of the styrene-(meth)acrylic resin having a crosslinking structure, so that the domain B of the styrene-(meth)acrylic resin is unlikely to be present in the fixed image; and the spherical domain A of the styrene-(meth)acrylic resin is flexible, so that the low-temperature fixability is excellent and the occurrence of fogging can be suppressed.

Hereinafter, the configuration of the electrostatic charge image developing toner according to the present exemplary embodiment will be described in detail.

### Toner Particles

The toner particles contain a binder resin, and optionally contain a colorant, a release agent, and other additives.

### Spherical Domains A and B of Styrene-(Meth)Acrylic Resin

The above-described toner particles contain a styrene-(meth)acrylic resin.

The toner particles have the spherical domain A of the styrene-(meth)acrylic resin, that is insoluble in tetrahydrofuran, and the spherical domain B of the styrene-(meth)acrylic resin, that is soluble in tetrahydrofuran, the glass transition temperature Tg1 of the spherical domain A of the styrene-(meth)acrylic resin is 0° C. or higher and 35° C. or lower, and in a case where a glass transition temperature of the spherical domain B of the styrene-(meth)acrylic resin is denoted by Tg2, the value of Tg2−Tg1 is 20° C. or higher and 55° C. or lower.

### Extraction of Spherical Domain a of Styrene-(Meth)Acrylic Resin Insoluble in Tetrahydrofuran

(1) 0.25 g of the toner is weighed, 40 mL of tetrahydrofuran (THF) is added thereto, and the mixture is mixed and stirred for 3 hours.

(2) The mixed solution obtained in (1) is separated by a centrifuge at 2,000 rpm for 30 minutes.

(3) The precipitate after centrifugation obtained in (2) is taken out, washed with methanol, and THF is removed.

(4) The washed precipitate is transferred to an aluminum dish or the like, and the methanol component is evaporated and dried in a vacuum dryer in which a temperature is adjusted to 50° C.

(5) 40 mL of THF is added to the obtained dried substance, and the mixture is mixed and stirred at 85° C. for 1 hour.

(6) The mixed solution obtained in (5) is filtered without being cooled, and THF-insoluble components are extracted; the THF-insoluble components are transferred to an aluminum dish or the like, and the THF component is evaporated and dried in a vacuum dryer in which a temperature is adjusted to 50° C., thereby obtaining the spherical domain A of the styrene-(meth)acrylic resin, isolated from the toner.

### Glass Transition Temperatures Tg1 and Tg2

The above-described glass transition temperature Tg1 of the spherical domain A of the styrene-(meth)acrylic resin is 0° C. or higher and 35° C. or lower, and from the viewpoint of fogging suppression property and low-temperature fixability, the glass transition temperature is, for example, preferably 10° C. or higher and 35° C. or lower, more preferably 14° C. or higher and 30° C. or lower, and particularly preferably 16° C. or higher and 25° C. or lower.

From the viewpoint of fogging suppression property and low-temperature fixability, the glass transition temperature Tg2 of the spherical domain B of the styrene-(meth)acrylic resin is, for example, preferably 35° C. or higher and 70° C. or lower, more preferably 40° C. or higher and 65° C. or lower, and particularly preferably 50° C. or higher and 60° C. or lower.

In the toner particles according to the present exemplary embodiment, the value of Tg2−Tg1 is 20° C. or higher and 55° C. or lower, and from the viewpoint of fogging suppression property and low-temperature fixability, the value is, for example, preferably 25° C. or higher and 55° C. or lower, more preferably 30° C. or higher and 50° C. or lower, and particularly preferably 35° C. or higher and 45° C. or lower.

The fact that the spherical domains A and B are styrene-(meth)acrylic resins can be determined by nuclear magnetic resonance (NMR) measurement of the toner particles.

In the present exemplary embodiment, the Tg1 of the spherical domain A of the styrene-(meth)acrylic resin is measured by measuring tetrahydrofuran (THF) insoluble components of the toner particles with a differential scanning calorimetry (DSC) device.

In addition, in the present exemplary embodiment, the Tg2 of the spherical domain B of the styrene-(meth)acrylic resin is measured by calculating a constitutional ratio of the monomer by nuclear magnetic resonance (NMR) measurement of the toner particles and to calculate the Tg2 using the FOX equation. That is, the measurement and calculation are performed by the following method.

First, a ratio of constitutional monomers of the styrene-(meth)acrylic resin is quantified from the NMR analysis.

Next, the glass transition temperatures Tg2 is calculated from the respective ratio of the constitutional monomers obtained above by the FOX equation. Specifically, the glass transition temperatures are obtained as follows.

In a case where a glass transition temperature of a homopolymer of the (meth)acrylate-based monomer is denoted by TgA (K), a ratio (mass proportion; % by mass) of the (meth)acrylate-based monomer is denoted by WA, a glass transition temperature of a homopolymer of the styrene-based monomer is denoted by TgS (K), and a ratio (mass proportion; % by mass) of the styrene-based monomer is denoted by WS, a target glass transition temperature Tg0 (K) satisfies the following FOX equation.

$$1 / Tg 0 = ( WA / TgA ) + ( WS / TgS ) \qquad FOX equation$$

By substituting the glass transition temperature and the ratio of each (meth)acrylate-based monomer and the glass transition temperature and the ratio of the styrene-based monomer in the entire resin particles or on the surface of the resin particles into the FOX equation, Tg0=“target glass transition temperature Tg1 or Tg2” is calculated by the FOX equation.

The glass transition temperature of the homopolymer of the (meth)acrylate-based monomer and the glass transition temperature of the homopolymer of the styrene-based monomer may be measured values or catalog values.

The adjustment of Tg1, Tg2, and the like in the spherical domains A and B of the styrene-(meth)acrylic resin can be achieved by adjusting the monomer formulation of the copolymer, adjusting the amount of the crosslinking agent, and the like.

### Content of Styrene-(Meth)Acrylic Resin

From the viewpoint of fogging suppression property and low-temperature fixability, a content W1 of the styrene-(meth)acrylic resin constituting the spherical domain A of the styrene-(meth)acrylic resin is, for example, preferably 1.5% by mass or more and 30% by mass or less, more preferably 3% by mass or more and 20% by mass or less, and particularly preferably 5% by mass or more and 15% by mass or less with respect to the total mass of the toner particles.

From the viewpoint of fogging suppression property and low-temperature fixability, a content W2 of the styrene-(meth)acrylic resin constituting the spherical domain B of the styrene-(meth)acrylic resin is, for example, preferably 1.5% by mass or more and 25% by mass or less, more preferably 3% by mass or more and 18% by mass or less, and particularly preferably 5% by mass or more and 12% by mass or less with respect to the total mass of the toner particles.

In addition, from the viewpoint of fogging suppression property and low-temperature fixability, for example, it is preferable that the content W1 of the styrene-(meth)acrylic resin constituting the spherical domain A of the styrene-(meth)acrylic resin is larger than the content W2 of the styrene-(meth)acrylic resin constituting the spherical domain B of the styrene-(meth)acrylic resin.

In addition, from the viewpoint of fogging suppression property and low-temperature fixability, a value of W1/W2 is, for example, preferably 0.3 or more and 3.0 or less, more preferably 0.8 or more and 2.5 or less, and particularly preferably more than 1.0 and 2.0 or less.

In other words, from the viewpoint of fogging suppression property and low-temperature fixability, the value of W1/W2 preferably satisfies Expression A-1, more preferably satisfies Expression A-2, and particularly preferably satisfies Expression A-3.

$$0.3 \leq W 1 / W 2 \leq 3. \qquad Expression A - 1$$

$$0.8 \leq W 1 / W 2 \leq 2.5 \qquad Expression A - 2$$

$$1. \leq W 1 / W 2 \leq 2. \qquad Expression A - 3$$

In addition, from the viewpoint of fogging suppression property and low-temperature fixability, a value of W1+W2 is, for example, preferably 5% by mass or more and 40% by mass or less, more preferably 10% by mass or more and 30% by mass or less, and particularly preferably 15% by mass or more and 25% by mass or less.

In other words, from the viewpoint of fogging suppression property and low-temperature fixability, the value of W1+W2 preferably satisfies Expression B-1, more preferably satisfies Expression B-2, and particularly preferably satisfies Expression B-3. The unit of the numerical value of the following expressions is % by mass.

$$5 \leq W 1 + W 2 \leq 40 \qquad Expression B - 1$$

$$10 \leq W 1 + W 2 \leq 30 \qquad Expression B - 2$$

$$15 \leq W 1 + W 2 \leq 25 \qquad Expression B - 3$$

### Domain Diameter of Spherical Domains A and B of Styrene-(Meth)Acrylic Resin

The above-described toner particles have the spherical domain A of the styrene-(meth)acrylic resin and the spherical domain B of the styrene-(meth)acrylic resin.

A shape of the above-described domain may be spherical, and may be a true spherical shape, an ellipsoidal shape, a boulder shape, an oval shape, an irregular spherical shape, or the like.

A distribution of domain diameters of the above-described domains has two peaks, and has a peak in a range of 50 nm or more and 300 nm or less and a peak in a range of 300 nm or more and 800 nm or less.

From the viewpoint of fogging suppression property and low-temperature fixability, the domain diameter of the spherical domain A of the styrene-(meth)acrylic resin is, for example, preferably 50 nm or more and 300 nm or less, more preferably 80 nm or more and 280 nm or less, and particularly preferably 100 nm or more and 250 nm or less.

From the viewpoint of fogging suppression property and low-temperature fixability, the domain diameter of the spherical domain B of the styrene-(meth)acrylic resin is, for example, preferably 300 nm or more and 800 nm or less, more preferably 300 nm or more and 700 nm or less, and particularly preferably 350 nm or more and 600 nm or less.

In addition, from the viewpoint of fogging suppression property and low-temperature fixability, for example, it is preferable that the domain diameter of the spherical domain A of the styrene-(meth)acrylic resin is smaller than the domain diameter of the spherical domain B of the styrene-(meth)acrylic resin.

As a measurement method of the domain diameter in the present exemplary embodiment, in a cross section of the toner particles, 50 low-Tg domains A and 50 high-Tg domains B are observed by an atomic force microscope-infrared spectroscopy (AFM-IR), and the maximum length of each domain is measured. An arithmetic mean of the maximum lengths is defined as a domain diameter.

The cross-sectional sample of the toner particles is prepared by embedding the toner particles in a bisphenol A-type liquid epoxy resin and a curing agent, preparing a cutting sample, and then cutting the cutting sample at −100° C. using a cutting machine using a diamond knife, for example, a LEICA ultramicrotome (manufactured by Hitachi High-Technologies Corporation) to produce a cross-sectional observation sample.

### Monomer Configuration of Styrene-(Meth)Acrylic Resin

Examples of the styrene-(meth)acrylic resin in the present exemplary embodiment include a resin obtained by polymerizing a (meth)acrylic monomer such as the following styrene-based monomer and (meth)acrylate-based monomer by radical polymerization.

Examples of the styrene-based monomer include styrene, α-methylstyrene, vinylnaphthalene; alkyl-substituted styrene with an alkyl chain, such as 2-methylstyrene, 3-methylstyrene, 4-methylstyrene, 2-ethylstyrene, 3-ethylstyrene, and 4-ethylstyrene; halogen-substituted styrene such as 2-chlorostyrene, 3-chlorostyrene, and 4-chlorostyrene; and fluorine-substituted styrene such as 4-fluorostyrene and 2,5-difluorostyrene. Among the styrene-based monomers, for example, styrene or α-methylstyrene is preferable.

Examples of the (meth)acrylate monomer include methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, 2-carboxyethyl (meth)acrylate, (meth)acrylonitrile, and (meth)acrylamide.

As the (meth)acrylate-based monomer, from the viewpoint of ease of adjusting Tg1 and Tg2 of the styrene-(meth)acrylic resin, for example, a (meth)acrylate compound having an alkyl group having 2 to 12 carbon atoms (also referred to as “number of carbon atoms”) is preferable, a (meth)acrylate compound having an alkyl group having 2 to 10 carbon atoms is more preferable, and a (meth)acrylate compound having an alkyl group having 4 to 7 carbon atoms is particularly preferable.

Among the above, as the (meth)acrylate-based monomer, from the viewpoint of case of adjusting Tg1 and Tg2 of the styrene-(meth)acrylic resin, for example, n-butyl (meth)acrylate is particularly preferable.

In addition, from the viewpoint of case of adjusting Tg1 and Tg2, for example, it is preferable that a proportion of the (meth)acrylate-based monomer in all monomers constituting the spherical domain A of the styrene-(meth)acrylic resin is larger than a proportion of the (meth)acrylate-based monomer in all monomers constituting the spherical domain B of the styrene-(meth)acrylic resin.

For example, the styrene-(meth)acrylic resin constituting the spherical domain A of the styrene-(meth)acrylic resin preferably has a crosslinked structure.

In addition, the styrene-(meth)acrylic resin constituting the spherical domain B of the styrene-(meth)acrylic resin may have a crosslinked structure.

Examples of a crosslinking agent for forming a crosslinked structure include aromatic polyfunctional vinyl compounds such as divinylbenzene and divinylnaphthalene; polyvalent vinyl esters of aromatic polyvalent carboxylic acids, such as divinyl phthalate, divinyl isophthalate, divinyl terephthalate, divinyl homophthalate, divinyl trimesate, trivinyl trimesate, divinyl naphthalenedicarboxylate, and divinyl biphenylcarboxylate; divinyl esters of nitrogen-containing aromatic compounds, such as divinyl pyridine dicarboxylate; vinyl esters of unsaturated heterocyclic carboxylic acid compounds, such as vinyl pyromutate, vinyl furan carboxylate, vinyl pyrrole-2-carboxylate, and vinyl thiophene carboxylate; (meth)acrylic acid esters of linear polyhydric alcohols, such as butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, dodecanediol diacrylate, and dodecanediol dimethacrylate; (meth)acrylic acid esters of branched substituted polyhydric alcohols, such as neopentylglycol dimethacrylate and 2-hydroxy, 1,3-diacryloxypropane; and polyfunctional vinyl esters of polyvalent carboxylic acids, such as polyethylene glycol di(meth)acrylate, polypropylene polyethylene glycol di(meth)acrylates, divinyl succinate, divinyl fumarate, vinyl maleate, divinyl maleate, divinyl diglycolate, vinyl itaconate, divinyl itaconate, divinyl acetone dicarboxylate, divinyl glutarate, 3,3′-divinylthiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. One kind of crosslinking agent may be used alone, or two or more kinds of crosslinking agents may be used in combination.

Among the above, as the crosslinking agent, for example, it is preferable to use an alkylene glycol diacrylate having an alkylene chain having 6 or more carbon atoms. That is, for example, the resin particles preferably have a constitutional unit derived from an alkylene glycol diacrylate, and the number of carbon atoms in the alkylene chain of the alkylene glycol diacrylate is preferably 6 or more.

In a case of using a resin having a constitutional unit derived from an alkylene glycol diacrylate and having an alkylene chain having 6 or more carbon atoms, a crosslinking density is low (that is, a distance between crosslinking points is long), and thus it is possible to suppress the excessive increase in elasticity of the resin.

From the viewpoint of adjusting the crosslinking density to an appropriate range, the number of carbon atoms in the alkylene chain of the alkylene glycol diacrylate is, for example, preferably 6 or more, more preferably 6 or more and 12 or less, and still more preferably 8 or more and 12 or less. More specific examples of the alkylene glycol diacrylate include 1,6-hexanediol acrylate, 1,6-hexanediol methacrylate, 1,8-octanediol diacrylate, 1,8-octanediol dimethacrylate, 1,9-nonanediol diacrylate, 1,9-nonanediol dimethacrylate, 1,10-decanediol diacrylate, 1,10-decanediol dimethacrylate, 1,12-dodecanediol diacrylate, and 1,12-dodecanediol dimethacrylate, and among these, for example, 1,10-decanediol diacrylate or 1,10-decanediol dimethacrylate is preferable.

Examples of other crosslinking agents include 2-carboxyethyl acrylate, and for example, it is preferable to use at least one of the above-described bifunctional alkyl acrylate or 2-carboxyethyl acrylate.

A content of the crosslinking agent with respect to the total of 100 parts by mass of the styrene-based monomer and the (meth)acrylate-based monomer, that are used for forming the styrene-(meth)acrylic resin, is, for example, preferably 0.3 parts by mass or more and 5.0 parts by mass or less, more preferably 0.4 parts by mass or more and 3.0 parts by mass or less, and still more preferably 0.5 parts by mass or more and 2.5 parts by mass or less.

The toner particles may contain internally-added resin particles other than the styrene (meth)acrylic resin particles constituting the spherical domains A and B of the styrene-(meth)acrylic resin.

### Binder Resin

The toner particles contain, as a binder resin, an amorphous polyester resin in addition to the styrene-(meth)acrylic resin constituting the spherical domains A and B of the styrene-(meth)acrylic resin.

In addition, the toner particles may contain a binder resin other than the amorphous polyester resin and the styrene-(meth)acrylic resin constituting the spherical domains A and B of the styrene-(meth)acrylic resin.

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin is suitable.

Examples of the polyester resin include known amorphous polyester resins. As the polyester resin, a crystalline polyester resin may be used in combination with an amorphous polyester resin. However, a content of the crystalline polyester resin may be, for example, in a range of 2% by mass or more and 40% by mass or less (for example, preferably 5% by mass or more and 30% by mass or less) with respect to all binder resins.

In addition, from the viewpoint of low-temperature fixability and heat storage properties, for example, the binder resin preferably includes a crystalline resin, and more preferably includes a crystalline polyester resin.

The “crystalline” resin indicates that a clear endothermic peak is present in differential scanning calorimetry (DSC) rather than a stepwise change in endothermic amount and specifically indicates that the half-width of the endothermic peak in a case of measurement at a temperature rising rate of 10 (C/min) is within 10° C.

On the other hand, the “amorphous” resin indicates that the half-width is higher than 10° C., a stepwise change in endothermic amount is shown, or a clear endothermic peak is not recognized.

### Amorphous Polyester Resin

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid (hexenyl succinic acid, octenyl succinic acid, dodecenyl succinic acid, pentadecenyl succinic acid, and the like), adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

From the viewpoint of fogging suppression property and low-temperature fixability, an acid value of the amorphous polyester resin is, for example, preferably 3 mgKOH/g or more and 30 mgKOH/g or less, more preferably 6 mgKOH/g or more and 16 mgKOH/g or less, and particularly preferably 8 mgKOH/g or more and 12 mgKOH/g or less.

The acid value of the amorphous polyester resin is determined by a neutralization titration method specified in JIS K0070-1992 using an appropriate amount of the amorphous polyester resin as a sample.

The glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

A weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC⋅HLC-8320GPC manufactured by Tosoh Corporation as a measurement device, TSKgel Super HM-M (15 cm) manufactured by Tosoh Corporation as a column, and tetrahydrofuran (THF) as a solvent. The weight-average molecular weight and the number-average molecular weight are calculated using a molecular weight calibration curve plotted using a monodisperse polystyrene standard sample from the measurement results.

One kind of amorphous polyester resin may be used alone, or two or more kinds of amorphous polyester resins may be used in combination. In a case where two or more kinds thereof are used in combination, for example, a high-molecular-weight form and a low-molecular-weight form may be used in combination.

The amorphous polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the reaction, for example, the monomer with poor compatibility may be condensed in advance with an acid or an alcohol that is to be polycondensed with the monomer, and then polycondensed together with the principle component.

### Crystalline Polyester Resin

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 2 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among the aliphatic diols, for example, 1,6-hexanediol, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

The melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The weight-average molecular weight (Mw) of the crystalline polyester resin is, for example, preferably 6,000 or more and 50,000 or less.

The crystalline polyester resin can be obtained by a known manufacturing method, for example, same as the amorphous polyester resin.

A hybrid resin having a polyester resin segment and a styrene-acrylic copolymer segment may be adopted as the polyester resin.

A content of the binder resin with respect to the total amount of the toner particles is, for example, preferably 40% by mass or more and 95% by mass or less, more preferably 50% by mass or more and 90% by mass or less, and still more preferably 60% by mass or more and 90% by mass or less.

### Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; inorganic pigments such as a titanium compound, silica, aluminum, and mica; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

The colorant is not limited to a substance having absorption in the visible light region. The colorant may be, for example, a substance having absorption in a near infrared region, a fluorescent colorant, or a colorant having lustrousness.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

The content of the colorant with respect to the total amount of the toner particles is, for example, preferably 1% by mass or more and 30% by mass or less, and more preferably 3% by mass or more and 15% by mass or less.

### Release Agent

Examples of the release agent include hydrocarbon-based wax; natural wax such as carnauba wax, rice wax, and candelilla wax; synthetic or mineral⋅petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The content of the release agent with respect to the total amount of the toner particles is, for example, preferably 1% by mass or more and 20% by mass or less, and more preferably 4% by mass or more and 15% by mass or less.

### Other Additives

Examples of other additives include known additives such as a magnetic material, a charge control agent, and inorganic powder. The additives are incorporated into the toner particles as internal additives.

### Characteristics and the Like of Toner Particles

The toner particles may be toner particles that have a single-layer structure or toner particles having a so-called core/shell structure that is configured with a core portion (core particle) and a coating layer (shell layer) coating the core portion.

The volume-average particle size (D50v) of the toner particles is, for example, preferably 2 μm or more and 10 μm or less, and more preferably 4 μm or more and 8 μm or less.

The various average particle sizes and various particle size distribution indexes of the toner particles are measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-average particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-average particle size D84v and a number-based particle size D84p.

By using these, a volume particle size distribution index (GSDv) is calculated as (D84v/D16v)^{1/2}, and a number particle size distribution index (GSDp) is calculated as (D84p/D16p)^{1/2}.

The average circularity of the toner particles is, for example, preferably 0.90 or more and 1.00 or less, and more preferably 0.92 or more and 0.98 or less.

The average circularity of the toner particles is determined by (Equivalent circular perimeter)/(Perimeter) [(Perimeter of circle having the same projected area as particle image)/(Perimeter of projected particle image)]. Specifically, the average circularity is a value measured by the following method.

First, toner particles as a measurement target are collected by suction, and a flat flow of the particles is formed. Thereafter, an instant flash of strobe light is emitted to the particles, and the particles are imaged as a still image. By using a flow-type particle image analyzer (Parshe Analyzer PAS, manufactured by HOSOKAWA MICRON CORPORATION) performing image analysis on the particle image, the average circularity is determined. The number of samplings for determining the average circularity is 10,000.

In a case where a toner contains the external additive, the toner (developer) as a measurement target is dispersed in water containing a surfactant, then the dispersion is treated with ultrasonic waves such that the external additive is removed, and the toner particles are collected.

### External Additive

Examples of the external additive include inorganic particles. Examples of the inorganic particles include SiO₂, TiO₂, Al₂O₃, SrTiO₃, CaTiO₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobization treatment. The hydrophobization treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning lubricant (for example, and a metal salt of a higher fatty acid represented by zinc stearate or particles of higher alcohols).

The amount of the external additive externally added with respect to the toner particles is, for example, preferably 0.01% by mass or more and 10% by mass or less, and more preferably 0.01% by mass or more and 6.0% by mass or less.

### Manufacturing Method of Electrostatic Charge Image Developing Toner

The electrostatic charge image developing toner according to the present exemplary embodiment is obtained by producing toner particles and then adding the external additive to the exterior of the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). These manufacturing methods are not particularly limited, and known manufacturing methods are adopted. Among the above methods, for example, the aggregation and coalescence method may be used for obtaining toner particles.

Specifically, in a case where the toner particles are manufactured by the aggregation and coalescence method, for example, the toner particles are manufactured through a step (first aggregated particle-forming step) of forming first aggregated particles by mixing a first resin particle dispersion in which first resin particles as a binder resin are dispersed, a colorant dispersion in which a colorant is dispersed, and a release agent particle dispersion in which particles of a release agent (hereinafter, also referred to as “release agent particles”) are dispersed, and aggregating the particles and the colorant in the obtained dispersion; a step (second aggregated particle-forming step) of forming second aggregated particles by, after obtaining the first aggregated particle dispersion in which the first aggregated particles are dispersed, adding second resin particles as a binder resin to the first aggregated particle dispersion, and aggregating the second resin particles on a surface of the first aggregated particles; and a step (coalescence step) of heating the second aggregated particle dispersion in which the second aggregated particles are dispersed to allow the second aggregated particles to undergo coalescence and to form toner particles.

The present aggregation and coalescence method will be described as a method for producing toner particles containing a binder resin, a colorant, and a release agent; but the colorant and the release agent are components to be contained in the toner particles as necessary.

Hereinafter, each of the steps will be specifically described.

### Each Dispersion Preparing Step

First, each dispersion to be used in the aggregation and coalescence method is prepared. Specifically, a first resin particle dispersion in which first resin particles as a binder resin are dispersed, a colorant dispersion in which a colorant is dispersed, a second resin particle dispersion in which second resin particles as a binder resin are dispersed, and a release agent particle dispersion in which release agent particles are dispersed are respectively prepared.

In each dispersion preparing step, the first resin particles and the second resin particles will be referred to as “resin particles” in the following description.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase inversion) from W/O to O/W, turns into a discontinuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 μm or more and 0.8 μm or less, and still more preferably 0.1 μm or more and 0.6 μm or less.

For determining the volume-average particle size of the resin particles, a particle size distribution is measured using a laser diffraction type particle size distribution analyzer (for example, LA-960 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant dispersion and a release agent particle dispersion are prepared in the same manner as that adopted for preparing the resin particle dispersion. That is, the volume-average particle size of the particles, the dispersion medium, the dispersion method, and the content of the particles in the resin particle dispersion are also applied to the colorant to be dispersed in the colorant dispersion and the release agent particles to be dispersed in the release agent particle dispersion.

### First Aggregated Particle-Forming Step

Next, the first resin particle dispersion is mixed with the colorant dispersion and the release agent particle dispersion.

In the mixed dispersion, the first resin particles, the colorant, and the release agent particles are hetero-aggregated to form the first aggregated particles including the first resin particles, the colorant, and the release agent particles.

Specifically, for example, an aggregating agent is added to a dispersion obtained by mixing the first resin particle dispersion, the colorant dispersion, and the release agent particle dispersion; the pH of the mixed dispersion is adjusted to acidic (for example, pH of 2 or more and 5 or less); a dispersion stabilizer is added thereto as necessary; the temperature is set to a temperature region of 20° C. or higher and 50° C. or lower; and the particles dispersed in the mixed dispersion are aggregated to form the first aggregated particles.

In the first aggregated particle-forming step, for example, in a state where the mixed dispersion is stirred with a rotary shearing homogenizer, the aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. In particular, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added with respect to 100 parts by mass of the first resin particles is, for example, preferably 0.01 parts by mass or more and 5.0 parts by mass or less, and more preferably 0.1 parts by mass or more and less than 3.0 parts by mass.

In addition, in order to adjust the effect of the chelating agent, an alkali may be added to adjust the pH in the system.

### Second Aggregated Particle-Forming Step

Next, after obtaining the first aggregated particle dispersion in which the first aggregated particles are dispersed, a second resin particle dispersion in which second resin particles are dispersed is added to the first aggregated particle dispersion.

The second resin particles may be of the same type as the first resin particles, or may be of different types.

Next, the second resin particles are aggregated on the surface of the first aggregated particles in the dispersion of the first aggregated particles and the second resin particles. In this case, by adding the release agent particle dispersion, the second resin particles and the release agent particles may be aggregated on the surface of the first aggregated particles. Specifically, for example, in the first aggregated particle-forming step, in a case where the first aggregated particles reach a target particle size, the second resin particle dispersion is added to the first aggregated particle dispersion, and the mixture is heated at a temperature equal to or lower than the glass transition temperature of the second resin particles.

By setting the pH of the dispersion in a range of, for example, about 6.5 or more and 8.5 or less, the progress of aggregation is stopped.

In this way, the second aggregated particles are obtained in which the second resin particles are aggregated so as to adhere to the surface of the first aggregated particles.

### Coalescence Step

Next, the second aggregated particle dispersion in which the second aggregated particles are dispersed is heated to, for example, a temperature equal to or higher than the glass transition temperatures of the first and second amorphous resin particles (for example, a temperature higher than the glass transition temperatures of the first and second resin particles by 10° C. to 30° C.) such that the second aggregated particles coalesce, thereby forming toner particles.

In addition, in order to control the shape, the pH in the system may be adjusted by adding an acid as necessary.

The toner particles are obtained through the above steps.

In the aggregation and coalescence method described above, the first aggregated particles may be coalesced to form the toner particles without performing the second aggregated particle-forming step. In addition, the second aggregated particle-forming step may be repeated a plurality of times.

Here, after the coalescence step ends, the toner particles in the dispersion are subjected to known washing step, solid-liquid separation step, and drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

For example, by adding an external additive to the obtained dry toner particles and mixing the external additive and the toner particles together, the toner according to the present exemplary embodiment is manufactured. The mixing may be performed, for example, using a V blender, a Henschel mixer, a Lodge mixer, or the like. In addition, the external additive may be mixed with the toner particles at once, or the external additive may be added to the toner particles stepwise and mixed a plurality of times. Furthermore, coarse particles of the toner may be removed as necessary by using a vibratory sieving machine, a pneumatic sieving machine, or the like.

### Electrostatic Charge Image Developer

The electrostatic charge image developer according to the present exemplary embodiment contains at least the electrostatic charge image developing toner according to the present exemplary embodiment.

The electrostatic charge image developer according to the present exemplary embodiment may be a one-component developer that contains only the electrostatic charge image developing toner according to the present exemplary embodiment or a two-component developer that is obtained by mixing the electrostatic charge image developing toner and a carrier together.

The carrier is not particularly limited, and examples thereof include known carriers. Examples of the carrier include a coated carrier obtained by coating the surface of a core material consisting of magnetic powder with a resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating the surface of a core material, that is particles configuring the carrier, with a resin.

Examples of the magnetic powder include magnetic metals such as iron, nickel, and cobalt; and magnetic oxides such as ferrite and magnetite.

In particular, as a magnetic powder, for example, magnetite or ferrite is preferable. The magnetic powder may be used as particles in which the magnetic powder is dispersed in a resin.

Examples of the coating resin and the matrix resin include a styrene. (meth)acrylic acid resin; polyolefin-based resins such as a polyethylene resin and a polypropylene resin; polyvinyl-based or polyvinylidene-based resins such as a polystyrene-(meth)acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride⋅vinyl acetate copolymer; a straight silicone resin consisting of an organosiloxane bond or a modified product thereof; a fluororesin such as polytetrafluoroethylene, polyvinyl fluoride, polyvinylidene fluoride, or polychlorotrifluoroethylene; polyester; polyurethane; polycarbonate; an amino resin such as a urea formaldehyde resin; and an epoxy resin.

For example, the coating resin and the matrix resin preferably contain a (meth)acrylic resin, and preferably contain a (meth)acrylic resin having an alicyclic structure. The coating resin and the matrix resin may contain a nitrogen-containing (meth)acrylic resin.

For example, a content of the (meth)acrylic resin is more preferably 50% by mass or more, and still more preferably 80% by mass or more with respect to the total mass of the resins.

In particular, for example, the coating resin and the matrix resin preferably contain an alicyclic (meth)acrylic resin as the (meth)acrylic resin.

The coating resin and the matrix resin may contain other additives such as conductive particles. Examples of the conductive particles include metals such as gold, silver, and copper, and particles such as carbon black, titanium oxide, zinc oxide, tin oxide, barium sulfate, aluminum borate, and potassium titanate.

Examples of the other additives include particles overlapping with the above-described conductive particles, but also include metal oxide particles such as silica, titanium oxide, zinc oxide, and tin oxide; metal compound particles such as barium sulfate, aluminum borate, and potassium titanate; and metal particles such as gold, silver, and copper. Among the above, for example, silica particles are preferable.

A content of the above-described particles is, for example, preferably 10% by mass or more and 60% by mass or less with respect to the total mass of the resin layer.

The surface of the core material is coated with a resin, for example, by a coating method using a solution for forming a coating layer obtained by dissolving the coating resin and various additives (used as necessary) in an appropriate solvent, and the like. The solvent is not particularly limited, and may be selected in consideration of the type of the resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and then removing solvents.

The mixing ratio (mass ratio) between the toner and the carrier, represented by toner:carrier, in the two-component developer is, for example, preferably 1:100 to 30:100, and more preferably 3:100 to 20:100.

### Image Forming Apparatus and Image Forming Method

The image forming apparatus and image forming method according to the present exemplary embodiment will be described.

The image forming apparatus according to the present exemplary embodiment includes an image holder, a charging device that charges the surface of the image holder, an electrostatic charge image forming device that forms an electrostatic charge image on the charged surface of the image holder, a developing device that contains an electrostatic charge image developer and develops the electrostatic charge image formed on the surface of the image holder as a toner image by using the electrostatic charge image developer, a transfer device that transfers the toner image formed on the surface of the image holder to the surface of a recording medium, and a fixing device that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed that has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; and an apparatus including a cleaning device that cleans the surface of the image holder before charging after the transfer of the toner image or an apparatus including a charge neutralization device that neutralizes charge by irradiating the surface of the image holder with charge neutralizing light before charging after the transfer of the toner image.

In the case of the intermediate transfer-type apparatus, as the transfer device, for example, a configuration is adopted that has an intermediate transfer member with surface on which the toner image will be transferred, a primary transfer device that performs primary transfer to transfer the toner image formed on the surface of the image holder to the surface of the intermediate transfer member, and a secondary transfer device that performs secondary transfer to transfer the toner image transferred to the surface of the intermediate transfer member to the surface of a recording medium.

In the image forming apparatus according to the present exemplary embodiment, for example, a portion including the developing device may be a cartridge structure (process cartridge) to be detachable from the image forming apparatus. As the process cartridge, for example, a process cartridge is suitably used that includes a developing device that contains the electrostatic charge image developer according to the present exemplary embodiment.

An example of the image forming apparatus according to the present exemplary embodiment will be shown below, but the present invention is not limited thereto. Hereinafter, among the parts shown in the drawing, main parts will be described, and others will not be described.

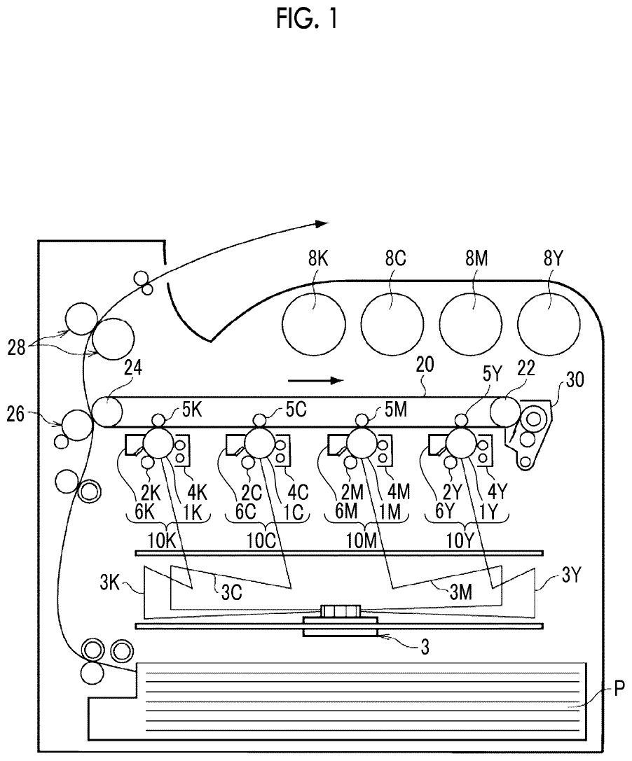

FIG. 1 is a view schematically showing the configuration of the image forming apparatus according to the present exemplary embodiment.

The image forming apparatus shown in FIG. 1 includes first to fourth image forming units 10Y, 10M, 10C, and 10K adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detached from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 that in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the outer peripheral surface of the intermediate transfer belt 20.

In addition, a toner including toners having four colors of yellow, magenta, cyan, and black, that are contained in containers of toner cartridges 8Y, 8M, 8C, and 8K, is supplied to developing devices (example of the developing device) 4Y, 4M, 4C, and 4K of the units 10Y, 10M, 10C, and 10K, respectively.

The first to fourth units 10Y, 10M, 10C, and 10K have the same configuration. Therefore, in the present specification, as a representative, the first unit 10Y will be described that placed on the upstream side of the running direction of the intermediate transfer belt and forms a yellow image. Reference numerals marked with magenta (M), cyan (C), and black (K) instead of yellow (Y) are assigned in the same portions as in the first unit 10Y, such that the second to fourth units 10M, 10C, and 10K will not be described again.

The first unit 10Y has a photoreceptor 1Y that acts as an image holder. Around the photoreceptor 1Y, a charging roll (an example of the charging device) 2Y that charges the surface of the photoreceptor 1Y at a predetermined potential, an exposure device (an example of the electrostatic charge image forming device) 3 that exposes the charged surface to a laser beam 3Y based on color-separated image signals to form an electrostatic charge image, a developing device (an example of the developing device) 4Y that develops the electrostatic charge image by supplying a charged toner to the electrostatic charge image, a primary transfer roll (an example of the primary transfer device) 5Y that transfers the developed toner image onto the intermediate transfer belt 20, and a photoreceptor cleaning device (an example of the cleaning device) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.:1×10⁻⁶ Ω·cm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y. As a result, an electrostatic charge image of a yellow image pattern is formed on the surface of the photoreceptor 1Y.

The electrostatic charge image is an image formed on the surface of the photoreceptor 1Y by charging. The image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y turns into a visible image (developed image) as a toner image by the developing device 4Y.

The developing device 4Y contains, for example, an electrostatic charge image developer that contains at least a yellow toner and a carrier. By being stirred in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 μA under the control of the control unit (not shown in the drawing).

On the other hand, the residual toner on the photoreceptor 1Y is removed by a photoreceptor cleaning device 6Y and collected.

In addition, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll (an example of the secondary transfer device) 26 disposed on the outer peripheral surface side of the intermediate transfer belt 20. On the other hand, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting device (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of the fixing device), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

### Process Cartridge and Toner Cartridge

The process cartridge according to the present exemplary embodiment will be described.

The process cartridge according to the present exemplary embodiment includes a developing device that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other devices, such as an image holder, a charging device, an electrostatic charge image forming device, and a transfer device, as necessary.

An example of the process cartridge according to the present exemplary embodiment will be shown below, but the present invention is not limited thereto. Hereinafter, among the parts shown in the drawing, main parts will be described, and others will not be described.

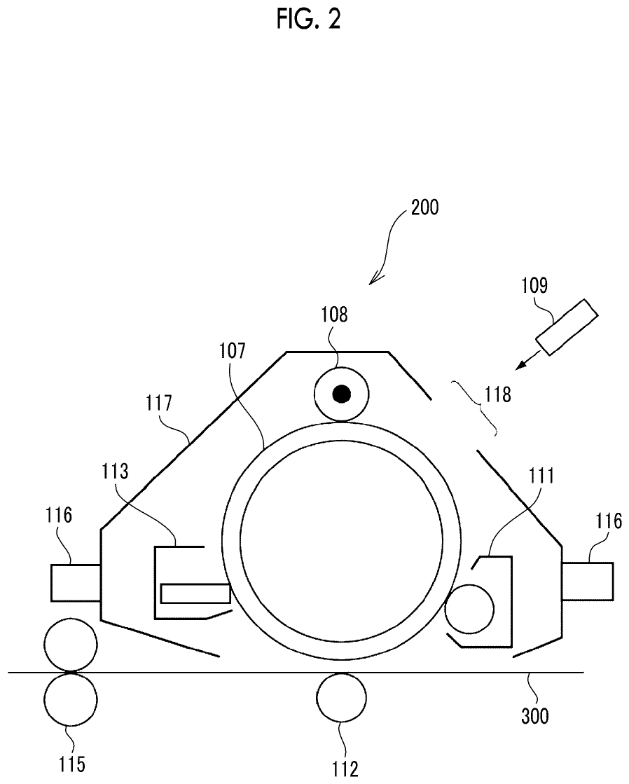

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging device) that is provided on the periphery of the photoreceptor 107, a developing device 111 (an example of developing device), a photoreceptor cleaning device 113 (an example of cleaning device), that are integrally combined and held in the housing 117. The process cartridge 200 forms a cartridge in this way.

In FIG. 2, 109 represents an exposure device (an example of electrostatic charge image forming device), 112 represents a transfer device (an example of transfer device), 115 represents a fixing device (an example of fixing device), and 300 represents recording paper (an example of recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing device provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In addition, in a case where the amount of the toner contained in the container of the toner cartridge is low, the toner cartridge is replaced.

### EXAMPLES

Hereinafter, exemplary embodiments of the present invention will be specifically described based on Examples. However, the exemplary embodiments of the present invention are not limited to Examples.

In the following description, unless otherwise specified, “parts” and “%” are based on mass.

Unless otherwise specified, the synthesis, treatment, manufacturing, and the like are carried out at room temperature (25° C.±3° C.).

### Example 1

### Preparation of Styrene-(Meth)Acrylate Copolymer Particle Dispersion (1) for Forming Spherical Domain A

Styrene: 50 parts
n-Butyl acrylate (BA): 50 parts
1,10-Decanediol diacrylate (DDDA): 1.0 part
Anionic surfactant (ELEMINOL MON-2, manufactured by Sanyo Chemical Industries, Ltd.): 1.2 parts
Deionized water: 86 parts

The above-described materials are charged into a mixing vessel equipped with a stirrer, and stirred to prepare an emulsion.

0.3 parts of the anionic surfactant (ELEMINOL MON-2, manufactured by Sanyo Chemical Industries, Ltd.) and 100 parts of deionized water are added to a reaction vessel equipped with a stirrer and a nitrogen introduction tube, after replacing the inside of the reaction vessel with nitrogen. The reaction solution is heated in an oil bath while being stirred so that a temperature of the reaction solution is set to 75° C.

After adding 3 parts of the emulsion thereto, 20 parts of an ammonium persulfate aqueous solution in which a concentration is adjusted to 10% by mass is further added thereto, and the reaction solution is retained for 30 minutes.

Thereafter, in a state where the temperature of the reaction solution is maintained at 75° C., the emulsion is gradually added dropwise to the reaction vessel over 200 minutes by a pump. After completion of the dropwise addition, the solution is retained for 60 minutes, 2 parts of ammonium persulfate having a concentration of 10% by mass is added thereto, and the mixture is retained for another 3 hours and then cooled to room temperature. The obtained dispersion of resin particles is sieved through a sieve with a 70 μm mesh to remove aggregates generated in the polymerization step, thereby obtaining a styrene-(meth)acrylate copolymer particle dispersion (1) for forming a spherical domain A.

### Preparation of Styrene-(Meth)acrylate Copolymer Particle Dispersion (2) for Forming Spherical Domain B

Styrene: 76 parts
n-Butyl acrylate: 24 parts
1,10-Decanediol diacrylate: 0.1 parts
Dodecanethiol: 0.7 parts
Anionic surfactant (ELEMINOL MON-2, manufactured by Sanyo Chemical Industries, Ltd.): 1.2 parts
Deionized water: 86 parts

A styrene-(meth)acrylate copolymer particle dispersion (2) for forming a spherical domain B is obtained by the same procedure as that for the styrene-(meth)acrylate copolymer particle dispersion (1), except that the raw material formulation is changed as described above.

### Preparation of Amorphous Resin Particle Dispersion 1

Terephthalic acid: 98 parts by mole
Trimellitic acid anhydride: 2 parts by mole
Ethylene oxide (2 mol) adduct of bisphenol A: 20 parts by mole
Propylene oxide (2 mol) adduct of bisphenol A: 80 parts by mole

The above-described materials are charged into a reaction vessel equipped with a stirrer, a nitrogen introduction tube, a temperature sensor, and a rectifying column, the temperature is raised to 190° C. over 1 hour, and dibutyltin oxide is added to the mixture in an amount of 1.2 parts with respect to 100 parts of the above-described materials. While the generated water is distilled off, the temperature is raised to 240° C. for 6 hours, a dehydration condensation reaction is continued for 3 hours in the reaction solution retained at 240° C., and then the reactant is cooled.

The reactant in a molten state is transferred to CAVITRON CD1010 (manufactured by Eurotech Ltd.) at a rate of 100 g/min. At the same time, separately prepared aqueous ammonia having a concentration of 0.37% by mass is transferred to CAVITRON CD1010 at a rate of 0.1 L/min in a state of being heated at 120° C. with a heat exchanger. The CAVITRON CD1010 is operated under the conditions of a rotation speed of a rotor of 60 Hz and a pressure of 5 kg/cm², thereby obtaining a resin particle dispersion in which resin particles having a volume-average particle size of 150 nm are dispersed. Deionized water is added to the resin particle dispersion to adjust the solid content to 20% by mass, thereby obtaining an amorphous resin particle dispersion 1.

### Preparation of Crystalline Resin Particle Dispersion 1

1,10-Dodecanedioic acid: 225 parts by mass
1,10-Dodecanediol: 174 parts by mass

The above-described materials are charged into a reaction vessel equipped with a stirrer, a nitrogen introduction tube, a temperature sensor, and a rectifying column, the temperature is raised to 160° C. over 1 hour, and 0.8 parts by mass of dibutyltin oxide is added thereto. While the generated water is distilled off, the temperature is raised to 180° C. for 6 hours, and a dehydration condensation reaction is continued for 5 hours in the reaction solution retained at 180° C. Thereafter, the temperature is slowly raised to 230° C. under reduced pressure, and the reaction solution is stirred for 2 hours in a state of being retained at 230° C. Thereafter, the reaction product is cooled. After the cooling, solid-liquid separation is performed, and the solids are dried, thereby obtaining a crystalline polyester resin.
Crystalline polyester resin (1): 100 parts
Methyl ethyl ketone: 40 parts
Isopropyl alcohol: 30 parts
10% Aqueous ammonia solution: 6 parts

The above-described materials are put in a jacketed reaction tank (manufactured by TOKYO RIKAKIKAI CO., LTD.: BJ-30N) equipped with a condenser, a thermometer, a water dripping device, and an anchor blade. In a state where the reaction tank is kept at 80° C. in a water-circulation type thermostatic bath, and the materials are stirred and mixed together at 100 rpm, the resin is dissolved. Thereafter, the water-circulation type thermostatic bath is set to 50° C., and a total of 400 parts of deionized water retained at 50° C. is added dropwise to the reaction tank at a rate of 7 parts by mass/min to cause phase inversion, thereby obtaining an emulsion. 576 parts by mass of the obtained emulsion and 500 parts by mass of deionized water are put in a eggplant flask and set in an evaporator (manufactured by TOKYO RIKAKIKAI CO., LTD.) equipped with a vacuum controlled unit through a trap ball. While being rotated, the eggplant flask is heated in a hot water bath at 60° C., and the pressure is reduced to 7 kPa with care to sudden boiling, thereby removing the solvent. Thereafter, deionized water is added thereto to obtain a crystalline resin particle dispersion 1 having a concentration of solid contents of 20% by mass.

### Preparation of Colorant Dispersion

Carbon black (manufactured by Cabot Corporation, Regal 330): 50 parts
Anionic surfactant (manufactured by DKS Co., Ltd., NEOGEN RK): 5 parts
Deionized water: 192.9 parts

The above components are mixed together and treated with ULTIMAIZER (manufactured by SUGINO MACHINE LIMITED) at 240 MPa for 10 minutes, thereby preparing a colorant dispersion (solid content: 20%).

### Preparation of Release Agent Particle Dispersion

Fischer-Tropsch wax (FNP0090 manufactured by NIPPON SEIRO CO., LTD., melting temperature Tw: 90° C.): 50 parts
Anionic surfactant (manufactured by DKS Co., Ltd., NEOGEN RK): 1 part
Deionized water: 200 parts

The above-described materials are mixed together, heated to 130° C., and dispersed using a homogenizer (ULTRA-TURRAX T50 manufactured by IKA). Thereafter, using Manton-Gaulin high-pressure homogenizer (manufactured by Gaulin), dispersion treatment is performed, thereby obtaining a release agent particle dispersion (solid content: 20% by mass) in which release agent particles are dispersed.

### Production of Toner Particles 1

Amorphous resin particle dispersion 1: 170 parts
Crystalline resin particle dispersion: 16 parts
Styrene-(meth)acrylate copolymer particle dispersion (1): 31 parts
Styrene-(meth)acrylate copolymer particle dispersion (2): 24 parts
Colorant dispersion: 40 parts
Release agent particle dispersion: 25 parts
Anionic surfactant (manufactured by DKS Co., Ltd., NEOGEN RK): 1 part
Deionized water: 250 parts

The above materials are put in a reactor equipped with a thermometer, a pH meter, and a stirrer, heated to a temperature of 30° C. from the outside with a mantle heater, and kept as it is for 30 minutes while being stirred at a rotation speed of 150 rpm. Next, a 0.3N(=0.3 mol/L) nitric acid aqueous solution is added thereto such that the pH is adjusted to 3.0, and then 3% by mass polyaluminum chloride aqueous solution is added thereto in a state in which the reaction solution is dispersed with a homogenizer (ULTRA-TURRAX T50 manufactured by IKA). Next, the temperature is raised to 50° C. while stirring, and maintained for 30 minutes. Next, 149 parts of the amorphous resin particle dispersion is added thereto and retained for 1 hour, a 0.1 N(=0.1 mol/L) sodium hydroxide aqueous solution is added thereto such that the pH is adjusted to 8.5, and the mixture is heated to 90° C. while being continuously stirred, and retained for 5 hours. Thereafter, cooling, solid-liquid separation, washing and drying of the solids are sequentially carried out, thereby obtaining toner particles 1 having a volume-average particle size of 6.0 μm.

### Production of Toner 1

100 parts of the toner particles 1 and 2.0 parts of hydrophobic silica (manufactured by Nippon Aerosil Co., Ltd.; product name: RY200) are mixed with a Henshell mixer to obtain a toner 1.

### Examples 2 to 30 and Comparative Examples 1 to 6

Each toner is produced in the same manner as in Example 1, except that the preparation of the styrene-(meth)acrylate copolymer particle dispersion (1) for forming a spherical domain A, the preparation of the styrene-(meth)acrylate copolymer particle dispersion (2) for forming a spherical domain B, the preparation of the amorphous resin particle dispersion 1, and the production of the toner particles 1 are changed as shown in Table 1 or Table 2.

### Comparative Example 7

### Preparation of Seed Polymerization Particle Dispersion

### Preparation of Emulsion 1

Styrene: 27.8 parts
n-Butyl acrylate (BA): 27.8 parts
1,10-Decanediol diacrylate (DDDA): 0.6 parts
Anionic surfactant (ELEMINOL MON-2, manufactured by Sanyo Chemical Industries, Ltd.): 0.7 parts
Deionized water: 47.8 parts

The above-described materials are charged into a mixing vessel equipped with a stirrer, and stirred to prepare an emulsion 1.

### Preparation of Emulsion 2

Styrene: 33.8 parts
n-Butyl acrylate (BA): 10.7 parts
1,10-Decanediol diacrylate (DDDA): 0.1 parts
Dodecanethiol: 0.3 parts
Anionic surfactant (ELEMINOL MON-2, manufactured by Sanyo Chemical Industries, Ltd.): 0.5 parts
Deionized water: 38.2 parts

The above-described materials are charged into a mixing vessel equipped with a stirrer, and stirred to prepare an emulsion 2.

0.3 parts of the anionic surfactant (ELEMINOL MON-2, manufactured by Sanyo Chemical Industries, Ltd.) and 100 parts of deionized water are added to a reaction vessel equipped with a stirrer and a nitrogen introduction tube, after replacing the inside of the reaction vessel with nitrogen. The reaction solution is heated in an oil bath while being stirred so that a temperature of the reaction solution is set to 75° C.

After adding 3 parts of the emulsion 1 thereto, 20 parts of an ammonium persulfate aqueous solution in which a concentration is adjusted to 10% by mass is further added thereto, and the reaction solution is retained for 30 minutes.

Thereafter, in a state where the temperature of the reaction solution is maintained at 75° C., the emulsion 1 is gradually added dropwise to the reaction vessel over 111 minutes by a pump. After the completion of the dropwise addition, the mixture is allowed to stand for 15 minutes, and then the emulsion 2 is added dropwise thereto over 89 minutes using a pump. The solution is retained for 60 minutes, 2 parts of ammonium persulfate having a concentration of 10% by mass is added thereto, and the mixture is retained for another 3 hours and then cooled to room temperature. The obtained dispersion of resin particles is sieved through a sieve with a 70 μm mesh to remove aggregates generated in the polymerization step, thereby obtaining a seed polymerization particle dispersion.

### Method of Measuring Tg1 of Spherical Domain A of Styrene-(Meth)Acrylic Resin

A tetrahydrofuran (THF) insoluble amount of the toner particles is measured by a differential scanning calorimetry (DSC) device to measure Tg1.

### Method of Measuring Tg2 of Spherical Domain B of Styrene-(Meth)Acrylic Resin

A constitutional ratio of monomers is calculated by nuclear magnetic resonance (NMR) measurement of the toner particles, and Tg2 is calculated using the FOX equation.

### Method of Measuring Domain Diameter

In a cross section of the toner particles, a size of a low-Tg domain and a size of a high-Tg domain are measured by atomic force microscopy-infrared spectroscopy (AFM-IR), and the average value thereof is calculated.

### Evaluation of Low-temperature Fixability

Using DocuCentre Color 400 manufactured by FUJIFILM Business Innovation Corp., the obtained toner is used for printing out an unfixed image in a toner application amount adjusted to 13.5 g/m². As a recording medium, film synthetic paper (YUPO Paper, manufactured by YUPO CORPORATION) is used. The printed image is a 25 mm×25 mm solid image having an image density of 100%. A fixing evaluation device is prepared by detaching a fixing device from Apeos PortIV C3370 manufactured by FUJIFILM Business Innovation Corp., and modifying the machine so that fixing temperature can be changed. In the fixing evaluation device, the nip width is 6 mm, the nip pressure is 1.6 kgf/cm², and the process speed is 175 mm/sec. The unfixed image is fixed at a temperature from 90° C. to 180° C. at an interval of 5° C., a fixed image with no image defect and image disorder due to peeling failure is bent and a load of 50 g is applied thereto, and the degree of image defect in the portion is observed. The fixing temperature at which the degree of image defect is at a level at which a practical problem is not observed even though a slight peeling of the image is observed is evaluated as the minimum fixing temperature.

### Evaluation of Fogging Suppression Property

The toner cartridge is filled with the obtained toner, and attached to an image forming apparatus (machine prepared by modifying ApeosPort-IV C5575 manufactured by FUJIFILM Business Innovation Corp.). The developing device in the image forming apparatus is filled with the developer of each example.

In an environment of a temperature of 30° C. and a relative humidity of 85%, 10,000 sheets of an image with an image density of 5% are printed on A4-sized paper and left to stand for 24 hours. After the leaving, 10 images with an image density of 5% are printed on A4-sized paper. The 10 images are observed with the naked eye and a loupe with a magnification of 5 times, and the state of fogging is evaluated.

The evaluation standards are as follows.

A: no fogging is observed in the confirmation with a loupe.

B: in the confirmation with a loupe, 1 to 4 sheets with fogging are recognized, but there is no problem in practical use.

C: in the confirmation with a loupe, 5 or more sheets with fogging are recognized, but there is no problem in practical use.

D: in both the confirmation with a loupe and the visual confirmation, fogging is recognized in 5 or more sheets, that is not applicable for practical use.

TABLE 1

| | Spherical domain A of styrene-(meth)acrylic resin | | | | | | | | | Spherical domain B of styrene-(meth)acrylic resin | | | | |
|---|---|---|---|---|---|---|---|---|---|---|---|---|---|---|
| | Used | (Meth)acrylate | | Crosslinking | | | | | | Used | (Meth)acrylate | | Crosslinking | |
| | amount | compound | | agent | | | | | | amount | compound | | agent | |
| | of | | Used | | Used | | | | | of | | Used | | Used |
| | styrene | | amount | | amount | | W1 | Domain | | styrene | | amount | | amount |
| | (part by | | (part by | | (part by | Tgl | (% by | diameter | Solubility | (part by | | (part by | | (part by |
| | mass) | Type | mass) | Type | mass) | (° C.) | mass) | (nm) | in THF | mass) | Type | mass) | Type | mass) |
| Example | 50 | BA | 50 | DDDA | 1.0 | 15 | 10 | 150 | Insoluble | 76 | BA | 24 | DDDA | 0.1 |
| 1 | | | | | | | | | | | | | | |
| Example | 40 | BA | 60 | DDDA | 1.0 | 0 | 10 | 150 | Insoluble | 76 | BA | 24 | DDDA | 0.1 |
| 2 | | | | | | | | | | | | | | |
| Example | 46.5 | BA | 53.5 | DDDA | 1.0 | 10 | 10 | 150 | Insoluble | 76 | BA | 24 | DDDA | 0.1 |
| 3 | | | | | | | | | | | | | | |
| Example | 53 | BA | 47 | DDDA | 1.0 | 20 | 10 | 150 | Insoluble | 76 | BA | 24 | DDDA | 0.1 |
| 4 | | | | | | | | | | | | | | |
| Example | 63 | BA | 37 | DDDA | 1.0 | 35 | 10 | 150 | Insoluble | 76 | BA | 24 | DDDA | 0.1 |
| 5 | | | | | | | | | | | | | | |
| Example | 50 | BA | 50 | DDDA | 1.0 | 15 | 10 | 150 | Insoluble | 86 | BA | 14 | DDDA | 0.1 |
| 6 | | | | | | | | | | | | | | |
| Example | 50 | BA | 50 | DDDA | 1.0 | 15 | 10 | 150 | Insoluble | 79 | BA | 21 | DDDA | 0.1 |
| 7 | | | | | | | | | | | | | | |
| Example | 50 | BA | 50 | DDDA | 1.0 | 15 | 10 | 150 | Insoluble | 72.5 | BA | 27.5 | DDDA | 0.1 |
| 8 | | | | | | | | | | | | | | |
| Example | 50 | BA | 50 | DDDA | 1.0 | 15 | 10 | 150 | Insoluble | 63 | BA | 37 | DDDA | 0.1 |
| 9 | | | | | | | | | | | | | | |
| Example | 50 | BA | 50 | DDDA | 1.0 | 15 | 2.8 | 150 | Insoluble | 76 | BA | 24 | DDDA | 0.1 |
| 10 | | | | | | | | | | | | | | |
| Example | 50 | BA | 50 | DDDA | 1.0 | 15 | 7.2 | 150 | Insoluble | 76 | BA | 24 | DDDA | 0.1 |
| 11 | | | | | | | | | | | | | | |
| Example | 50 | BA | 50 | DDDA | 1.0 | 15 | 13.9 | 150 | Insoluble | 76 | BA | 24 | DDDA | 0.1 |
| 12 | | | | | | | | | | | | | | |
| Example | 50 | BA | 50 | DDDA | 1.0 | 15 | 22.2 | 150 | Insoluble | 76 | BA | 24 | DDDA | 0.1 |
| 13 | | | | | | | | | | | | | | |
| Example | 50 | BA | 50 | DDDA | 1.0 | 15 | 4.2 | 150 | Insoluble | 76 | BA | 24 | DDDA | 0.1 |
| 14 | | | | | | | | | | | | | | |
| Example | 50 | BA | 50 | DDDA | 1.0 | 15 | 9 | 150 | Insoluble | 76 | BA | 24 | DDDA | 0.1 |
| 15 | | | | | | | | | | | | | | |
| Example | 50 | BA | 50 | DDDA | 1.0 | 15 | 11.6 | 150 | Insoluble | 76 | BA | 24 | DDDA | 0.1 |
| 16 | | | | | | | | | | | | | | |
| Example | 50 | BA | 50 | DDDA | 1.0 | 15 | 13.5 | 150 | Insoluble | 76 | BA | 24 | DDDA | 0.1 |
| 17 | | | | | | | | | | | | | | |
| Example | 50 | BA | 50 | DDDA | 1.0 | 15 | 10 | 50 | Insoluble | 76 | BA | 24 | DDDA | 0.1 |
| 18 | | | | | | | | | | | | | | |
| Example | 50 | BA | 50 | DDDA | 1.0 | 15 | 10 | 120 | Insoluble | 76 | BA | 24 | DDDA | 0.1 |
| 19 | | | | | | | | | | | | | | |

| | | | | | | | | Acid value of | | |
|---|---|---|---|---|---|---|---|---|---|---|
| | Spherical domain B of styrene-(meth)acrylic resin | | | | | | W1 + | amorphous | Evaluation | |
| | | W2 | Domain | | Tg2 · | | W2 | polyester | Low- | Fogging |
| | Tg2 | (% by | diameter | Solubility | Tg1 | | (% by | resin | temperature | suppression |
| | (° C.) | mass) | (nm) | in THF | (° C.) | W2/W1 | mass) | (mgKOH/g) | fixability | property |
| Example | 55 | 8 | 450 | Soluble | 40 | 1.3 | 18 | 10 | A | A |
| 1 | | | | | | | | | | |
| Example | 55 | 8 | 450 | Soluble | 55 | 1.3 | 18 | 10 | A | C |
| 2 | | | | | | | | | | |
| Example | 55 | 8 | 450 | Soluble | 45 | 1.3 | 18 | 10 | A | A |
| 3 | | | | | | | | | | |
| Example | 55 | 8 | 450 | Soluble | 35 | 1.3 | 18 | 10 | A | A |
| 4 | | | | | | | | | | |
| Example | 55 | 8 | 450 | Soluble | 20 | 1.3 | 18 | 10 | C | A |
| 5 | | | | | | | | | | |
| Example | 70 | 8 | 450 | Soluble | 55 | 1.3 | 18 | 10 | C | A |
| 6 | | | | | | | | | | |
| Example | 60 | 8 | 450 | Soluble | 45 | 1.3 | 18 | 10 | A | A |
| 7 | | | | | | | | | | |
| Example | 50 | 8 | 450 | Soluble | 35 | 1.3 | 18 | 10 | A | A |
| 8 | | | | | | | | | | |
| Example | 35 | 8 | 450 | Soluble | 20 | 1.3 | 18 | 10 | A | C |
| 9 | | | | | | | | | | |
| Example | 55 | 2.2 | 450 | Soluble | 40 | 1.3 | 5 | 10 | A | B |
| 10 | | | | | | | | | | |
| Example | 55 | 5.8 | 450 | Soluble | 40 | 1.3 | 13 | 10 | A | A |
| 11 | | | | | | | | | | |
| Example | 55 | 11.1 | 450 | Soluble | 40 | 1.3 | 25 | 10 | A | A |
| 12 | | | | | | | | | | |
| Example | 55 | 17.8 | 450 | Soluble | 40 | 1.3 | 40 | 10 | B | A |
| 13 | | | | | | | | | | |
| Example | 55 | 13.8 | 450 | Soluble | 40 | 0.3 | 18 | 10 | B | A |
| 14 | | | | | | | | | | |
| Example | 55 | 9 | 450 | Soluble | 40 | 1.0 | 18 | 10 | A | A |
| 15 | | | | | | | | | | |
| Example | 55 | 6.4 | 450 | Soluble | 40 | 1.8 | 18 | 10 | A | A |
| 16 | | | | | | | | | | |
| Example | 55 | 4.5 | 450 | Soluble | 40 | 3.0 | 18 | 10 | A | B |
| 17 | | | | | | | | | | |
| Example | 55 | 8 | 450 | Soluble | 40 | 1.3 | 18 | 10 | B | A |
| 18 | | | | | | | | | | |
| Example | 55 | 8 | 450 | Soluble | 40 | 1.3 | 18 | 10 | A | A |
| 19 | | | | | | | | | | |

TABLE 2

| | |
|---|---|
| | Spherical domain B of |
| Spherical domain A of styrene-(meth)acrylic resin | styrene-(meth)acrylic resin |

| | Used | (Meth)acrylate | | Crosslinking | | | | | | Used | |
|---|---|---|---|---|---|---|---|---|---|---|---|
| | amount | compound | | agent | | | | | | amount | |
| | of | | Used | | Used | | | | | of | |
| | styrene | | amount | | amount | | W1 | | | styrene | |
| | (part | | (part | | (part | | (% | Domain | | (part | (Meth)acrylate |
| | by | | by | | by | Tgl | by | diameter | Solubility | by | compound |
| | mass) | Type | mass) | Type | mass) | (° C.) | mass) | (nm) | in THF | mass) | Type |
| Exam- | 50 | BA | 50 | DDDA | 1.0 | 15 | 10 | 200 | Insoluble | 76 | BA |
| ple 20 | | | | | | | | | | | |
| Exam- | 50 | BA | 50 | DDDA | 1.0 | 15 | 10 | 300 | Insoluble | 76 | BA |
| ple 21 | | | | | | | | | | | |
| Exam- | 50 | BA | 50 | DDDA | 1.0 | 15 | 10 | 150 | Insoluble | 76 | BA |
| ple 22 | | | | | | | | | | | |
| Exam- | 50 | BA | 50 | DDDA | 1.0 | 15 | 10 | 150 | Insoluble | 76 | BA |
| ple 23 | | | | | | | | | | | |
| Exam- | 50 | BA | 50 | DDDA | 1.0 | 15 | 10 | 150 | Insoluble | 76 | BA |
| ple 24 | | | | | | | | | | | |
| Exam- | 50 | BA | 50 | DDDA | 1.0 | 15 | 10 | 150 | Insoluble | 76 | BA |
| ple 25 | | | | | | | | | | | |
| Exam- | 50 | BA | 50 | DDDA | 1.0 | 15 | 10 | 150 | Insoluble | 76 | BA |
| ple 26 | | | | | | | | | | | |
| Exam- | 50 | BA | 50 | DDDA | 1.0 | 15 | 10 | 150 | Insoluble | 76 | BA |
| ple 27 | | | | | | | | | | | |
| Exam- | 50 | BA | 50 | DDDA | 1.0 | 15 | 10 | 150 | Insoluble | 76 | BA |
| ple 28 | | | | | | | | | | | |
| Exam- | 57.5 | 2EHA | 42.5 | DDDA | 1.0 | 15 | 10 | 150 | Insoluble | 76 | BA |
| ple 29 | | | | | | | | | | | |
| Exam- | 50 | BA | 50 | DDDA | 1.0 | 15 | 10 | 150 | Insoluble | 80 | 2EHA |
| ple 30 | | | | | | | | | | | |
| Compar- | 36.5 | BA | 63.5 | DDDA | 1.0 | −5 | 10 | 150 | Insoluble | 76 | BA |
| ative | | | | | | | | | | | |
| Exam- | | | | | | | | | | | |
| ple 1 | | | | | | | | | | | |
| Compar- | 66 | BA | 34 | DDDA | 1.0 | 40 | 10 | 150 | Insoluble | 76 | BA |
| ative | | | | | | | | | | | |
| Exam- | | | | | | | | | | | |
| ple 2 | | | | | | | | | | | |
| Compar- | 50 | BA | 50 | DDDA | 1.0 | 15 | 10 | 150 | Insoluble | 89 | BA |
| ative | | | | | | | | | | | |
| Exam- | | | | | | | | | | | |
| ple 3 | | | | | | | | | | | |
| Compar- | 50 | BA | 50 | DDDA | 1.0 | 15 | 10 | 150 | Insoluble | 59.5 | BA |
| ative | | | | | | | | | | | |
| Exam- | | | | | | | | | | | |
| ple 4 | | | | | | | | | | | |
| Compar- | 50 | BA | 50 | DDDA | 1.0 | 15 | 10 | 150 | Insoluble | — | — |
| ative | | | | | | | | | | | |
| Exam- | | | | | | | | | | | |
| ple 5 | | | | | | | | | | | |
| Compar- | — | — | — | — | — | — | — | — | — | 76 | BA |
| ative | | | | | | | | | | | |
| Exam- | | | | | | | | | | | |
| ple 6 | | | | | | | | | | | |

| | |
|---|---|
| Compar- | Seed polymerization particles |

ative
Exam-
ple 7

Spherical domain B of styrene-(meth)acrylic resin

| | (Meth)acrylate | Crosslinking | | | | | |
|---|---|---|---|---|---|---|---|
| | compound | agent | | | | | |
| | Used | | Used | | | | |
| | amount | | amount | | | | |
| | (part | | (part | | W2 | Domain | Solu- |
| | by | | by | Tg2 | (% by | diameter | bility |
| | mass) | Type | mass) | (° C.) | mass) | (nm) | in THF |
| Exam- | 24 | DDDA | 0.1 | 55 | 8 | 450 | Soluble |
| ple 20 | | | | | | | |
| Exam- | 24 | DDDA | 0.1 | 55 | 8 | 450 | Soluble |
| ple 21 | | | | | | | |
| Exam- | 24 | DDDA | 0.1 | 55 | 8 | 300 | Soluble |
| ple 22 | | | | | | | |
| Exam- | 24 | DDDA | 0.1 | 55 | 8 | 400 | Soluble |
| ple 23 | | | | | | | |
| Exam- | 24 | DDDA | 0.1 | 55 | 8 | 550 | Soluble |
| ple 24 | | | | | | | |
| Exam- | 24 | DDDA | 0.1 | 55 | 8 | 800 | Soluble |
| ple 25 | | | | | | | |
| Exam- | 24 | DDDA | 0.1 | 55 | 8 | 450 | Soluble |
| ple 26 | | | | | | | |
| Exam- | 24 | DDDA | 0.1 | 55 | 8 | 450 | Soluble |
| ple 27 | | | | | | | |
| Exam- | 24 | — | — | 55 | 8 | 450 | Soluble |
| ple 28 | | | | | | | |
| Exam- | 24 | DDDA | 0.1 | 55 | 8 | 450 | Soluble |
| ple 29 | | | | | | | |
| Exam- | 20 | DDDA | 0.1 | 55 | 8 | 450 | Soluble |
| ple 30 | | | | | | | |
| Compar- | 24 | DDDA | 0.1 | 55 | 8 | 450 | Soluble |
| ative | | | | | | | |
| Exam- | | | | | | | |
| ple 1 | | | | | | | |
| Compar- | 24 | DDDA | 0.1 | 55 | 8 | 450 | Soluble |
| ative | | | | | | | |
| Exam- | | | | | | | |
| ple 2 | | | | | | | |
| Compar- | 11 | DDDA | 0.1 | 75 | 8 | 450 | Soluble |
| ative | | | | | | | |
| Exam- | | | | | | | |
| ple 3 | | | | | | | |
| Compar- | 40.5 | DDDA | 0.1 | 30 | 8 | 450 | Soluble |
| ative | | | | | | | |
| Exam- | | | | | | | |
| ple 4 | | | | | | | |
| Compar- | — | — | — | — | — | — | — |
| ative | | | | | | | |
| Exam- | | | | | | | |
| ple 5 | | | | | | | |
| Compar- | 24 | DDDA | 0.1 | 55 | 8 | 450 | Soluble |
| ative | | | | | | | |
| Exam- | | | | | | | |
| ple 6 | | | | | | | |

| | |
|---|---|
| Compar- | Seed polymerization particles |

ative
Exam-
ple 7

| | | | | Acid | | |
|---|---|---|---|---|---|---|
| | | | | value | | |
| | | | | of | | |
| | | | | amor- | | |
| | | | | phous | Evaluation | |
| | | | W1 + | poly- | | Fogging |
| | | | W2 | ester | Low- | suppres- |
| | Tg2 · | | (% | resin | temper- | sion |
| | Tgl | | by | (mgKOH/ | ature | prop- |
| | (° C.) | W2/W1 | mass) | g) | fixability | erty |
| Exam- | 40 | 1.3 | 18 | 10 | A | A |
| ple 20 | | | | | | |
| Exam- | 40 | 1.3 | 18 | 10 | B | A |
| ple 21 | | | | | | |
| Exam- | 40 | 1.3 | 18 | 10 | A | B |
| ple 22 | | | | | | |
| Exam- | 40 | 1.3 | 18 | 10 | A | A |
| ple 23 | | | | | | |
| Exam- | 40 | 1.3 | 18 | 10 | A | A |
| ple 24 | | | | | | |
| Exam- | 40 | 1.3 | 18 | 10 | B | A |
| ple 25 | | | | | | |
| Exam- | 40 | 1.3 | 18 | 6 | B | A |
| ple 26 | | | | | | |
| Exam- | 40 | 1.3 | 18 | 16 | A | B |
| ple 27 | | | | | | |
| Exam- | 40 | 1.3 | 18 | 10 | A | A |
| ple 28 | | | | | | |
| Exam- | 40 | 1.3 | 18 | 10 | A | A |
| ple 29 | | | | | | |
| Exam- | 40 | 1.3 | 18 | 10 | A | A |
| ple 30 | | | | | | |
| Compar- | 60 | 1.3 | 18 | 10 | A | D |
| ative | | | | | | |
| Exam- | | | | | | |
| ple 1 | | | | | | |
| Compar- | 15 | 1.3 | 18 | 10 | D | A |
| ative | | | | | | |
| Exam- | | | | | | |
| ple 2 | | | | | | |
| Compar- | 60 | 1.3 | 18 | 10 | D | A |
| ative | | | | | | |
| Exam- | | | | | | |
| ple 3 | | | | | | |
| Compar- | 15 | 1.3 | 18 | 10 | A | D |
| ative | | | | | | |
| Exam- | | | | | | |
| ple 4 | | | | | | |
| Compar- | — | — | — | 10 | A | D |
| ative | | | | | | |
| Exam- | | | | | | |
| ple 5 | | | | | | |
| Compar- | — | — | — | 10 | D | A |
| ative | | | | | | |
| Exam- | | | | | | |
| ple 6 | | | | | | |
| Compar- | — | — | — | 10 | A | D |
| ative | | | | | | |
| Exam- | | | | | | |
| ple 7 | | | | | | |

Abbreviations shown in Table 2, other than the materials described above, are shown below.

### 2EHA: 2-Ethylhexyl Acrylate

As shown in Tables 1 and 2, the electrostatic charge image developing toners of Examples are excellent in both the fogging suppression property and the low-temperature fixability, as compared with the electrostatic charge image developing toners of Comparative Examples.

(((1))) An electrostatic charge image developing toner comprising:
toner particles that contain an amorphous polyester resin and a styrene-(meth)acrylic resin,
wherein the toner particles have a spherical domain A of the styrene-(meth)acrylic resin, that is insoluble in tetrahydrofuran, and a spherical domain B of the styrene-(meth)acrylic resin, that is soluble in tetrahydrofuran,
a glass transition temperature Tg1 of the spherical domain A of the styrene-(meth)acrylic resin is 0° C. or higher and 35° C. or lower, and
in a case where a glass transition temperature of the spherical domain B of the styrene-(meth)acrylic resin is denoted by Tg2, a value of Tg2−Tg1 is 20° C. or higher and 55° C. or lower.

(((2))) The electrostatic charge image developing toner according to (((1))),
wherein, in a case where, in the toner particles, a content of the styrene-(meth)acrylic resin constituting the spherical domain A of the styrene-(meth)acrylic resin is denoted by W1% by mass and a content of the styrene-(meth)acrylic resin constituting the spherical domain B of the styrene-(meth)acrylic resin is denoted by W2% by mass, 0.3≤W1/W2≤3.0 is satisfied.

(((3))) The electrostatic charge image developing toner according to (((1))) or (((2))),
wherein, in a case where, in the toner particles, a content of the styrene-(meth)acrylic resin constituting the spherical domain A of the styrene-(meth)acrylic resin is denoted by W1% by mass and a content of the styrene-(meth)acrylic resin constituting the spherical domain B of the styrene-(meth)acrylic resin is denoted by W2% by mass, 5≤W1+W2≤40 is satisfied.

(((4))) The electrostatic charge image developing toner according to any one of (((1))) to (((3))),
wherein, in the toner particles, a content of the styrene-(meth)acrylic resin constituting the spherical domain A of the styrene-(meth)acrylic resin is 1.5% by mass or more and 30% by mass or less.

(((5))) The electrostatic charge image developing toner according to any one of (((1))) to (((4))),
wherein, in the toner particles, a content of the styrene-(meth)acrylic resin constituting the spherical domain B of the styrene-(meth)acrylic resin is 1.5% by mass or more and 25% by mass or less.

(((6))) The electrostatic charge image developing toner according to any one of (((1))) to (((5))),
wherein a domain diameter of the spherical domain A of the styrene-(meth)acrylic resin is 50 nm or more and 300 nm or less.

(((7))) The electrostatic charge image developing toner according to any one of (((1))) to (((6))),
wherein a domain diameter of the spherical domain B of the styrene-(meth)acrylic resin is 300 nm or more and 800 nm or less.

(((8))) The electrostatic charge image developing toner according to any one of (((1))) to (((7))),
wherein a domain diameter of the spherical domain A of the styrene-(meth)acrylic resin is smaller than a domain diameter of the spherical domain B of the styrene-(meth)acrylic resin.

(((9))) The electrostatic charge image developing toner according to any one of (((1))) to (((8))),
wherein an acid value of the amorphous polyester resin is 6 mgKOH/g or more and 16 mgKOH/g or less.

(((10))) An electrostatic charge image developer comprising:
the electrostatic charge image developing toner according to any one of (((1))) to (((9))).

(((11))) A toner cartridge comprising:
a container that contains the electrostatic charge image developing toner according to any one of (((1))) to (((9))),
wherein the toner cartridge is detachable from an image forming apparatus.

(((12))) A process cartridge comprising:
a developing device that contains the electrostatic charge image developer according to (((10))) and develops an electrostatic charge image formed on a surface of an image holder as a toner image using the electrostatic charge image developer,
wherein the process cartridge is detachable from an image forming apparatus.

(((13))) An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to (((10))) and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.

(((14))) An image forming method comprising:
charging a surface of an image holder;
forming an electrostatic charge image on the charged surface of the image holder;
developing the electrostatic charge image formed on the surface of the image holder as a toner image using the electrostatic charge image developer according to (((10)));
transferring the toner image formed on the surface of the image holder to a surface of a recording medium; and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles that contain an amorphous polyester resin and a styrene-(meth)acrylic resin,
wherein the toner particles have a spherical domain A of the styrene-(meth)acrylic resin, that is insoluble in tetrahydrofuran, and a spherical domain B of the styrene-(meth)acrylic resin, that is soluble in tetrahydrofuran,
a glass transition temperature Tg1 of the spherical domain A of the styrene-(meth)acrylic resin is 0° C. or higher and 35° C. or lower, and
in a case where a glass transition temperature of the spherical domain B of the styrene-(meth)acrylic resin is denoted by Tg2, a value of Tg2−Tg1 is 20° C. or higher and 55° C. or lower.

2. The electrostatic charge image developing toner according to claim 1,
wherein, in a case where, in the toner particles, a content of the styrene-(meth)acrylic resin constituting the spherical domain A of the styrene-(meth)acrylic resin is denoted by W1% by mass and a content of the styrene-(meth)acrylic resin constituting the spherical domain B of the styrene-(meth)acrylic resin is denoted by W2% by mass, 0.3≤W1/W2≤3.0 is satisfied.

3. The electrostatic charge image developing toner according to claim 1,
wherein, in a case where, in the toner particles, a content of the styrene-(meth)acrylic resin constituting the spherical domain A of the styrene-(meth)acrylic resin is denoted by W1% by mass and a content of the styrene-(meth)acrylic resin constituting the spherical domain B of the styrene-(meth)acrylic resin is denoted by W2% by mass, 5≤W1+W2≤40 is satisfied.

4. The electrostatic charge image developing toner according to claim 1,
wherein, in the toner particles, a content of the styrene-(meth)acrylic resin constituting the spherical domain A of the styrene-(meth)acrylic resin is 1.5% by mass or more and 30% by mass or less.

5. The electrostatic charge image developing toner according to claim 1,
wherein, in the toner particles, a content of the styrene-(meth)acrylic resin constituting the spherical domain B of the styrene-(meth)acrylic resin is 1.5% by mass or more and 25% by mass or less.

6. The electrostatic charge image developing toner according to claim 1,
wherein a domain diameter of the spherical domain A of the styrene-(meth)acrylic resin is 50 nm or more and 300 nm or less.

7. The electrostatic charge image developing toner according to claim 1,
wherein a domain diameter of the spherical domain B of the styrene-(meth)acrylic resin is 300 nm or more and 800 nm or less.

8. The electrostatic charge image developing toner according to claim 1,
wherein a domain diameter of the spherical domain A of the styrene-(meth)acrylic resin is smaller than a domain diameter of the spherical domain B of the styrene-(meth)acrylic resin.

9. The electrostatic charge image developing toner according to claim 1,
wherein an acid value of the amorphous polyester resin is 6 mgKOH/g or more and 16 mgKOH/g or less.

10. An electrostatic charge image developer comprising:
the electrostatic charge image developing toner according to claim 1.

11. An electrostatic charge image developer comprising:
the electrostatic charge image developing toner according to claim 2.

12. An electrostatic charge image developer comprising:
the electrostatic charge image developing toner according to claim 3.

13. An electrostatic charge image developer comprising:
the electrostatic charge image developing toner according to claim 4.

14. An electrostatic charge image developer comprising:
the electrostatic charge image developing toner according to claim 5.

15. An electrostatic charge image developer comprising:
the electrostatic charge image developing toner according to claim 6.

16. An electrostatic charge image developer comprising:
the electrostatic charge image developing toner according to claim 7.

17. A toner cartridge comprising:
a container that contains the electrostatic charge image developing toner according to claim 1,
wherein the toner cartridge is detachable from an image forming apparatus.

18. A process cartridge comprising:
a developing device that contains the electrostatic charge image developer according to claim 10 and develops an electrostatic charge image formed on a surface of an image holder as a toner image using the electrostatic charge image developer,
wherein the process cartridge is detachable from an image forming apparatus.

19. An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to claim 10 and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image using the electrostatic charge image developer according to claim 10;
transferring the toner image formed on the surface of the image holder to a surface of a recording medium; and
fixing the toner image transferred to the surface of the recording medium.
